(19) United States
(12) Patent Application Publication
(10) Pub. No.: US 2023/0406408 A1
(43) Pub. Date: Dec. 21, 2023

(54) STEERING APPARATUS

(71) Applicant: HL MANDO CORPORATION, Gyeonggi-do (KR)

(72) Inventors: Youngbeom KIM, Gyeonggi-do (KR); DooChang SON, Gyeonggi-do (KR); Wooseok WON, Gyeonggi-do (KR); Cheonhyuk IM, Gyeonggi-do (KR)

(21) Appl. No.: 18/128,228

(22) Filed: Mar. 30, 2023

(30) Foreign Application Priority Data
Jun. 20, 2022 (KR) 10-2022-0074771

(51) Int. Cl. B62D 6/00; B62D 5/00; B60R 16/033; B60R 16/023

(52) U.S. Cl. CPC B62D 6/008; B62D 5/006; B60R 16/033; B60R 16/0231

(57) ABSTRACT

A steering apparatus includes a reaction force actuator generating a reaction force against operation of a steering control member operated by a driver of a vehicle, a reaction force control unit controlling the reaction force actuator based on an electrical signal associated with the operation of the steering control member, a steering actuator driving a steering mechanism steering a wheel of the vehicle, a steering control unit controlling the steering actuator based on the electrical signal, a first communication network connected to the reaction force control unit and the steering control unit and transmitting a control-related signal to the reaction force control unit and the steering control unit, and a second communication network connected to the reaction force control unit and the steering control unit independently of the first communication network to transmit the control-related signal to the reaction force control unit and the steering control unit.

### CROSS-REFERENCE TO RELATED APPLICATION

This application claims priority to and the benefit of Korean Patent Application No. 10-2022-0074771, filed on Jun. 20, 2022, the disclosure of which is incorporated herein by reference in its entirety.

### BACKGROUND

### 1. Technical Field

The present disclosure generally relates to a steering apparatus, and more specifically, to a steering apparatus for steering a direction of at least one wheel of a vehicle.

### 2. Discussion of Related Art

A steer-by-wire steering system may be a steering system in which a steering wheel and a wheel of a vehicle are not mechanically connected, and the wheel of the vehicle is steered by an electrical signal. In the steer-by-wire steering system, since the steering wheel and the wheel of the vehicle are not mechanically connected, there are advantages in terms of reducing the number of vehicle parts and the weight and minimizing a package of a steering assembly. In addition, the steer-by-wire steering system is advantageous in terms of functional expandability because steering is performed by the electrical signal. With electrification of vehicles and active development of autonomous driving technologies in recent years, demand for the steer-by-wire steering system is increasing.

In the steer-by-wire steering system, since a steering reaction system, which provides a steering reaction force, and a load wheel steering system, which controls adjusts a direction of the actual wheel of the vehicle, are not mechanically connected to each other as an operating principle, a network configuration for high responsiveness is required. In addition, implementation of an electronic control unit, independence for each network, and a system-level fall back concept is also required to satisfy the high standard of Automotive Software Integrity Level (ASIL).

### RELATED ART

### Patent Document

(Patent Document 1) Korean Patent No. 2086428 “STEER-BY-WIRE TYPE STEERING APPARATUS,” issued on Mar. 3, 2020

### SUMMARY

The present disclosure is for solving these problems and is directed to providing a steering apparatus having a network configuration which satisfies high responsiveness and independence for each network required for a steer-by-wire steering system.

In addition, the present disclosure is also directed to providing a steering apparatus capable of operating a steer-by-wire steering system even when one or some components of the steer-by-wire steering system fail.

Objectives of the present disclosure are not limited to the above-described objectives, and other objectives which are not described will be clearly understood by those skilled in the art from the following description.

According to an aspect of the present invention, there is provided a steering apparatus including a reaction force actuator which generates a reaction force against operation of a steering control member operated by a driver of a vehicle, a reaction force control unit which controls the reaction force actuator based on an electrical signal according to the operation of the steering control member, a steering actuator which drives a steering mechanism which adjusts a direction of a wheel of the vehicle, a steering control unit which controls the steering actuator based on the electrical signal, a first communication network which is connected to the reaction force control unit and the steering control unit and transmits control-related information to the reaction force control unit and the steering control unit, and a second communication network which is connected to the reaction force control unit and the steering control unit to be independent of the first communication network and transmits the control-related information to the reaction force control unit and the steering control unit.

In this case, the steering apparatus may further include a first power line which is connected to the reaction force control unit and the steering control unit and supplies power to the reaction force control unit and the steering control unit and a second power line which is connected to the reaction force control unit and the steering control unit to be independent of the first power line and supplies power to the reaction force control unit and the steering control unit;

The steering apparatus may further include a first battery connected to the first power line to provide power to the first power line and a second battery connected to the second power line to provide power to the second power line.

The steering apparatus may further include a communication line which directly connects the reaction force control unit and the steering control unit to allow information exchange between the reaction force control unit and the steering control unit.

The steering apparatus may further include a steering control sensor which measures a physical quantity related to the operation of the steering control member and provides the physical quantity to the reaction force control unit, wherein the electrical signal may have a correlation with the physical quantity.

The physical quantity may include a torque generated when the steering control member is operated.

The steering apparatus may further include a steering mechanism operation sensor which measures information related to operation of the steering mechanism and provides the information to the steering control unit.

The steering mechanism may include a linear moving member, and the information related to the operation of the steering mechanism may include a position of the linear moving member.

According to another aspect of the present invention, there is provided a steering apparatus including a reaction force actuator which generates a reaction force against operation of a steering control member operated by a driver of a vehicle, a first reaction force control unit which controls the reaction force actuator based on an electrical signal related to the operation of the steering control member, a second reaction force control unit which controls the reaction force actuator based on the electrical signal along with the first reaction force control unit or controls the reaction force actuator instead of the first reaction force control unit when the first reaction force control unit fails, a steering actuator which drives a steering mechanism which adjusts a direction of a wheel of the vehicle, a first steering control unit which controls the steering actuator based on the electrical signal, a second steering control unit which controls the steering actuator based on the electrical signal along with the first steering control unit or controls the steering actuator instead of the first steering control unit when the first steering control unit fails, a first communication network connected to the first reaction force control unit and the first steering control unit to transmit control-related information to the first reaction force control unit and the first steering control unit, and a second communication network connected to the second reaction force control unit and the second steering control unit to transmit the control-related information to the second reaction force control unit and the second steering control unit.

In this case, the steering apparatus may further include a first power line connected to the first reaction force control unit and the first steering control unit to supply power to the first reaction force control unit and the first steering control unit and a second power line connected to the second reaction force control unit and the second steering control unit to supply power to the second reaction force control unit and the second steering control unit.

The steering apparatus may further include a first battery connected to the first power line to provide power to the first power line and a second battery connected to the second power line to provide power to the second power line.

The steering apparatus may further include a first communication line which directly connects the first reaction force control unit and the first steering control unit to allow information exchange between the first reaction force control unit and the first steering control unit and a second communication line which directly connects the second reaction force control unit and the second steering control unit to allow information exchange between the second reaction force control unit and the second steering control unit.

The steering apparatus may further include a first steering control sensor which measures a physical quantity related to the operation of the steering control member and provides the physical quantity to the first reaction force control unit and a second steering control sensor which measures a physical quantity related to the operation of the steering control member and provides the physical quantity to the second reaction force control unit, wherein the electrical signal may have a correlation with the physical quantity.

The physical quantity may include a torque generated when the steering control member is operated.

The steering apparatus may further include a first steering mechanism operation sensor which measures information related to operation of the steering mechanism and provides the information to the first steering control unit and a second steering mechanism operation sensor which measures information related to the operation of the steering mechanism and provides the information to the second steering control unit.

The steering mechanism may include a linear moving member, and the information related to the operation of the steering mechanism may include a position of the linear moving member.

The steering apparatus may further include a communication line between the reaction force control units, which is disposed between and directly connected to the first reaction force control unit and the second reaction force control unit.

The steering apparatus may further include a communication line between the steering control units, which is disposed between and directly connected to the first steering control unit and the second steering control unit.

The first reaction force control unit may generate a control command for the reaction force actuator, the second reaction force control unit may receive the control command generated by the first reaction force control unit to control the reaction force actuator, and the second reaction force control unit may generate a control command for the reaction force actuator when the first reaction force control unit fails.

The reaction force actuator may be a reaction force motor which generates a reaction force, and the control command for the reaction force actuator may include a torque control command for the reaction force actuator.

The first steering control unit may generate a control command for the steering actuator, the second steering control unit may receive the control command generated by the first steering control unit to control the steering actuator, and the second steering control unit may generate a control command for the steering actuator when the first steering control unit fails.

The steering actuator may include a driving motor which drives the steering mechanism, and the control command for the steering actuator may include a torque control command for the steering actuator.

### BRIEF DESCRIPTION OF THE DRAWINGS

Not only detailed descriptions of exemplary embodiments of the present invention described below but also the summary described above will be understood more easily when read with reference to the accompanying drawings. The exemplary embodiments are illustrated in the drawings to illustrate the present invention. However, it should be understood that the present invention is not limited to the exact layout and method illustrated in the drawings, in which:

FIG. 1 is a configuration diagram illustrating a steering apparatus according to a first embodiment of the present disclosure;

FIG. 2 is a configuration diagram illustrating a steering apparatus according to a modified first embodiment of the present disclosure;

FIG. 3 is a configuration diagram illustrating a steering apparatus according to a second embodiment of the present disclosure;

FIG. 4 is a configuration diagram illustrating a steering apparatus according to a first modified example of the second embodiment of the present disclosure;

FIG. 5 is a configuration diagram illustrating a steering apparatus according to a second modified example of the second embodiment of the present disclosure;

FIG. 6 is a configuration diagram illustrating a steering apparatus according to a third modified example of the second embodiment of the present disclosure;

FIG. 7 is a configuration diagram illustrating a steering apparatus according to a fourth modified example of the second embodiment of the present disclosure;

FIG. 8 is a view showing an example of the second embodiment of the present disclosure in which two reaction force control units or controller are driven in a master/slave manner, and two steering control units are driven in a master/slave manner; and

FIG. 9 is a view showing an example of performing control by a slave when a master fails in FIG. 8 according to an embodiment of the present disclosure.

### DETAILED DESCRIPTION OF EXEMPLARY EMBODIMENTS

Hereinafter, embodiments of the present invention will be described in detail with reference to the accompanying drawings in order for those skilled in the art to easily perform the present invention. The present invention may be implemented in several different forms and is not limited to the embodiments described herein. Parts irrelevant to description are omitted in the drawings in order to clearly explain the present invention, and the same or similar parts are denoted by the same reference numerals throughout this specification.

Terms and words used in this specification and claims should not be interpreted as limited to commonly used meanings or meanings in dictionaries and should be interpreted with meanings and concepts which are consistent with the technological scope of the invention based on the principle that the inventors have appropriately defined concepts of the terms in order to describe the invention in the best way.

It should be further understood that the terms “comprise,” “include,” or the like, when used herein, specify the presence of stated features, numbers, steps, operations, elements, components, or groups thereof but do not preclude the presence or addition of one or more other features, numbers, steps, operations, elements, components, or groups thereof.

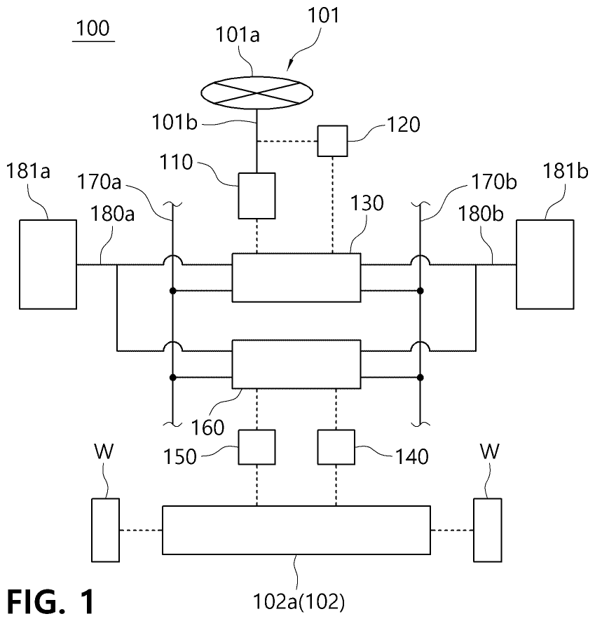

FIG. 1 is a configuration diagram illustrating a steering apparatus according to a first embodiment of the present disclosure.

A steering apparatus 100 according to the first embodiment of the present invention may be implemented as a steer-by-wire steering system. In the steer-by-wire steering system, a steering wheel and wheels of a vehicle are not mechanically connected and the wheel of the vehicle can be steered by an electrical signal, and the steer-by-wire steering system may have high responsiveness and independence for each network. The steering apparatus 100 according to the first embodiment of the present disclosure may include a reaction force actuator 110, a steering control sensor 120, a reaction force control unit (or controller) 130, a steering actuator 140, a steering mechanism operation sensor 150, a steering control unit (or controller) 160, a first communication network 170a, a second communication network 170b, a first power line 180a, and a second power line 180b.

The reaction force actuator 110 may be configured to generate a reaction force against, or in response to, movement or operation of a steering control member 101 operated or controlled by a driver of the vehicle. In the steering apparatus 100 according to the first embodiment of the present disclosure, since the steering control member 101 and wheels W of the vehicle are not mechanically connected, a reaction force torque associated with or caused by the change in a direction of the wheel W may not be naturally generated. In this situation, the reaction force generated by the reaction force actuator 110 may be provided to the driver through a steering wheel 101a so that the driver may feel an appropriate steering feeling.

For example, the steering control member 101 may include the steering wheel 101a of the vehicle and a steering shaft 101b coupled to the steering wheel 101a. The reaction force actuator 110 may provide the reaction force in a direction opposite to or in response to an operation or rotation direction of the steering wheel 101a through the steering shaft 101b. In the first embodiment of the present disclosure, the reaction force actuator 110 may be, for example, but not limited to, a reaction force motor configured to generate a reaction force torque.

The steering control sensor 120 may be configured to measure a physical quantity related to, or indicative of, the movement or operation of the steering control member 101 and provide the physical quantity to the reaction force control unit 130. The reaction force control unit 130 may perform control based on an electrical signal according to the movement or operation of the steering control member 101, and the electrical signal may have a correlation with the physical quantity. For example, the physical quantity may include a torque generated during the movement or operation of the steering control member 101. That is, the steering control sensor 120 may include a torque sensor. In addition, the steering control sensor 120 may include a steering angle sensor. In other words, the physical quantity may include a steering angle of the steering control member 101. In some exemplary embodiments of the present disclosure, the steering control sensor 120 may be configured to sense rotary movement (e.g. a steering angle, speed, or torque) associated with the steering wheel 101a and/or the steering shaft 101b.

The reaction force control unit (or controller) 130 may be configured to control the reaction force actuator 110 based on an electrical signal (for example, the electrical signal generated by the steering control sensor 120) according to the movement or operation of the steering control member 101. The reaction force control unit 130 may control the reaction force actuator 110 so that a reaction force corresponding to the electrical signal is generated. For example, when the reaction force actuator 110 is the reaction force motor which generates the reaction force torque, a control command generated by the reaction force control unit 130 may include a torque control command for controlling the torque of the reaction force actuator 110.

The reaction force control unit 130 may control the reaction force actuator 110 to generate a stronger reaction force as a level indicated by the electrical signal is larger. Accordingly, in a case in which a stronger torque is applied to the steering wheel 101a, or a steering angle is larger while the steering control member 101 is operated, the reaction force actuator 110 may generate a stronger reaction force so that a stable steering feeling may be provided to the driver of the vehicle.

The reaction force control unit or controller 130 may include, for example, but not be limited to, a processor, computer, digital signal processor (DSP), memory, storage, register, timing, interrupt, communication interface, and input/output signal interfaces, and the like, as well as combinations comprising at least one of the foregoing. For example, the reaction force control unit or controller 130 may comprise a processor, a storage medium and/or programmable memory, which are capable of storing and executing one or more algorithms, commands, signals, instructions or methods to effect control of the reaction force actuator 110 and, possibly, other components of the vehicle. The reaction force control unit or controller 130 may be in communication with the reaction force actuator 110, numerous sensors, communication systems, and other electronic control units (ECU) of the vehicle.

The steering actuator 140 is configured to drive a steering mechanism 102 configured to adjust or change a direction of the vehicle's wheels W. The steering mechanism 102 may be driven by the steering actuator 140, and the direction of the wheels W of the vehicle connected to the steering mechanism 102 may be adjusted or changed to perform steering of the vehicle. In the first embodiment of the present disclosure, the steering mechanism 102 may be driven by the steering actuator 140 independently of the steering control member 101 without being mechanically connected to the steering control member 101. For example, the steering actuator 140 may be a drive motor which drives the steering mechanism 102.

The steering mechanism 102 may include a linearly movable member 102a which is disposed between a pair of wheels W disposed at a front left side and a front right side of the vehicle, connected to the pair of wheels W through a tie rod (not shown), and linearly driven to adjust or change a direction of the wheels W. For example, the linearly movable member 102a may be a rack bar. In this case, the steering actuator 140 may be a drive motor which drives the linearly movable member 102a.

The steering mechanism operation sensor 150 is configured to sense or measure movement or operation of the steering mechanism 102, generate information related to the movement or operation of the steering mechanism 102, and provide the information to the steering control unit 160. The steering mechanism 102 is driven by the steering actuator 140, and the steering control unit 160 controls the steering actuator 140 based on the electrical signal, associated with the movement or operation of the steering control member 101, according to movement or operation of the steering control member 101. In this case, the steering mechanism operation sensor 150 provides the information related to the movement or operation of the steering mechanism 102 to the steering control unit 160 so that the information may be used for control together with the electrical signal associated with the movement or operation of the steering control member 101. The information related to the movement or operation of the steering mechanism 102 sensed or measured by the steering mechanism operation sensor 150 can reflect impacts, driving environment and the like generated on a road surface on which the vehicle is driving.

As described above, when the steering mechanism 102 includes the linearly movable member 102a, the information related to the movement or operation of the steering mechanism 102 may include a position of the linearly movable member 102a, or a position of the steering actuator 140 (e.g. a rotor of a motor). More specifically, when the linear moving member 102a is the rack bar, the steering mechanism operation sensor 150 may be a rack position sensor.

The steering control unit 160 controls the steering actuator 140 based on the electrical signal according to the operation or movement of the steering control member 101. The steering control unit 160 may control the steering actuator 140 to perform steering according to or in response to the electrical signal associated with the movement or operation of the steering control member 101. For example, when the steering actuator 140 is the drive motor which drives the steering mechanism 102, a control command generated by the steering control unit 160 may include a torque control command for the steering actuator 140.

The steering control unit 160 may control the steering actuator 140 to perform steering more as a level indicated by the electrical signal associated with the movement or operation of the steering control member 101 is larger. For example, in a case in which a stronger torque is generated in the steering control member 101, or a steering angle of the steering control member 101 is larger while the steering control member 101 is operated, steering is performed at a relatively larger angle, and in a case in which a relatively weaker torque is generated in the steering control member 101, or a steering angle of the steering control member 101 is smaller while the steering control member 101 is operated, steering is performed at a relatively smaller angle.

Meanwhile, the steering control unit 160 may use the information related to the movement or operation of the steering mechanism 102 sensed or measured by the steering mechanism operation sensor 150 to control the steering actuator 140. As described above, the information related to the movement or operation of the steering mechanism 102 measured by the steering mechanism operation sensor 150 may reflect the impacts, driving environment and the like generated on the road surface. The steering control unit 160 may control the steering actuator 140 by considering the information related to the movement or operation of the steering mechanism 102 in addition to the electrical signal associated with the movement or operation of the steering control member 101 in order to perform proper steering according to a road surface environment and the like.

The steering control unit or controller 160 may include, for example, but not be limited to, a processor, computer, digital signal processor (DSP), memory, storage, register(s), timing, interrupt(s), communication interface, and input/output signal interfaces, and the like, as well as combinations comprising at least one of the foregoing. For example, the steering control unit or controller 160 may comprise a processor, a storage medium and/or programmable memory, which are capable of storing and executing one or more algorithms, commands, signals, instructions or methods to effect control of the steering actuator 140 and, possibly, other components of the vehicle. The steering control unit or controller 160 may be in communication with the steering actuator 140, numerous sensors, communication systems, and other ECUs of the vehicle.

The first communication network 170a is communicationally connected to the reaction force control unit 130 and the steering control unit 160 to transmit control-related information to the reaction force control unit 130 and the steering control unit 160. For example, the first communication network 170a may be a controller area network (CAN) or data bus of the vehicle.

The reaction force control unit 130 and the steering control unit 160 basically control the reaction force actuator 110 and the steering actuator 140, respectively, based on the electrical signal according to the movement or operation of the steering control member 101. However, various control-related information such as a vehicle speed and autonomous driving commands of the vehicle may be transmitted to the reaction force control unit 130 and the steering control unit 160 in addition to the electrical signals, and the reaction force control unit 130 and the steering control unit 160 may perform control by considering the various control-related information in addition to the electrical signals. For example, even when electrical signals are the same, degrees of reaction force and steering of the vehicle may be controlled differently depending on a vehicle speed. In addition, when an autonomous driving command is transmitted, the reaction force control unit 130 may stop operating.

The various control-related information such as the vehicle speed and the autonomous driving commands described above may be transmitted to the reaction force control unit 130 and the steering control unit 160 through the first communication network 170a. The reaction force control unit 130 and the steering control unit 160 may use the control-related information received through the first communication network 170a for control.

The second communication network 170b may be connected to the reaction force control unit 130 and the steering control unit 160 to be independent of the first communication network 170a and may transmit the control-related information to the reaction force control unit 130 and the steering control unit 160. For example, the second communication network 170b may be a redundant CAN or data bus of the vehicle. Since the second communication network 170b is connected to the reaction force control unit 130 and the steering control unit 160 to be independent of the first communication network 170a, even when the control-related information such as the vehicle speed and the autonomous driving commands are not transmitted through the first communication network 170a due to a failure in the first communication network 170a, the control-related information may be transmitted through the second communication network 170b. Accordingly, high responsiveness required for the steer-by-wire steering system can be achieved, and system reliability can be improved by securing system redundancy.

The first power line 180a is connected to the reaction force control unit 130 and the steering control unit 160 to supply power to the reaction force control unit 130 and the steering control unit 160. The power supplied through the first power line 180a may also be supplied to the reaction force actuator 110, the steering control sensor 120, the steering actuator 140, and the steering mechanism operation sensor 150.

The second power line 180b may be connected to the reaction force control unit 130 and the steering control unit 160 to be independent of the first power line 180a and may supply power to the reaction force control unit 130 and the steering control unit 160. The power supplied through the second power line 180b may also be supplied to the reaction force actuator 110, the steering control sensor 120, the steering actuator 140, and the steering mechanism operation sensor 150.

In relation to the supply of power through the first power line 180a and the second power line 180b, the reaction force control unit 130 may include a regulator configured to adjust the power supplied to the reaction force actuator 110 and the steering control sensor 120. In addition, the steering control unit 160 may include a regulator configured to adjust the power supplied to the steering actuator 140 and the steering mechanism operation sensor 150.

Since the second power line 180b is connected to each of the reaction force control unit 130 and the steering control unit 160 to be independent of the first power line 180a, the power may be supplied to the reaction force control unit 130 and the steering control unit 160 through the second power line 180b even when power cannot be supplied through the first power line 180a due to a failure in the first power line 180a. Accordingly, system redundancy can be secured, and system reliability can be improved.

Meanwhile, the first power line 180a may be connected to a first battery 181a. That is, the first power line 180a may receive power from the first battery 181a. In addition, the second power line 180b may be connected to a second battery 181b. That is, the second power line 180b may receive power from the second battery 181b. As described above, the second power line 180b is provided independently of the first power line 180a, the power supplied to the second power line 180b is also provided separately from the power supplied to the first power line 180a, and thus redundancy can be secured more stably. However, alternatively, one battery can be connected to both the first and second power lines 180a and 180b.

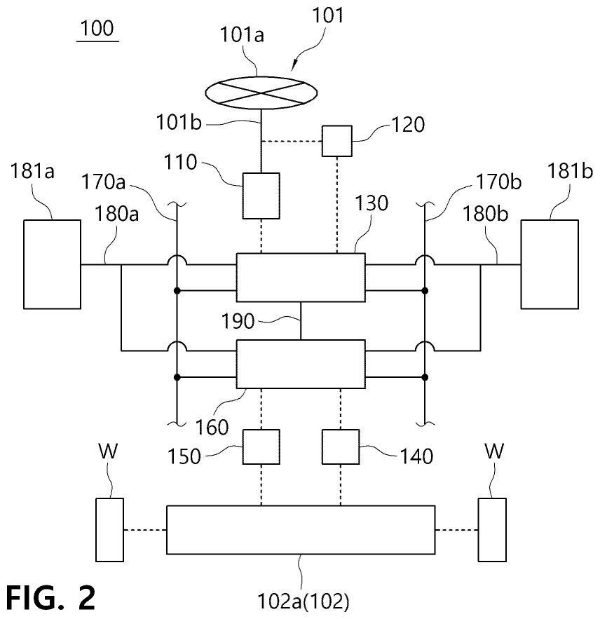

FIG. 2 is a configuration diagram illustrating a steering apparatus according to a modified first embodiment of the present disclosure.

Referring to FIG. 2, the steering apparatus according to the modified first embodiment of the present disclosure further includes a communication line 190 with comparison to the first embodiment of FIG. 1. Since the remaining components of the steering apparatus according to the modified first embodiment of FIG. 2 are same as or similar to those of the first embodiment of FIG. 1, only the communication line 190 will be described with respect to the modified example of the first embodiment of FIG. 1.

The communication line 190 directly connects the reaction force control unit or controller 130 and the steering control unit or controller 160 to allow signal, data or information exchange between the reaction force control unit 130 and the steering control unit 160.

As described above, the steering control unit 160 may use signal, data or information related to or associated with the movement or operation of the steering mechanism 102 and sensed or measured by the steering mechanism operation sensor 150 to control the steering actuator 140. This is because the signal, data or information related to or associated with the movement or operation of the steering mechanism 102 and sensed or measured by the steering mechanism operation sensor 150 includes impacts, driving environment and the like generated on a road surface, and by reflecting this signal, data or information in the control of the steering actuator 140, more appropriate steering control may be performed in correspondence with a road surface environment. The signal, data or information related to or associated with the movement or operation of the steering mechanism 102 may also be transmitted to the reaction force control unit 130 through the communication line 190. Accordingly, the reaction force control unit 130 may reflect the signal, data or information related to or associated with the movement or operation of the steering mechanism 102 and measured by the steering mechanism operation sensor 150 to the control of the reaction force actuator 110, and reaction force control can be performed more appropriately by reflecting feedback on the road surface environment.

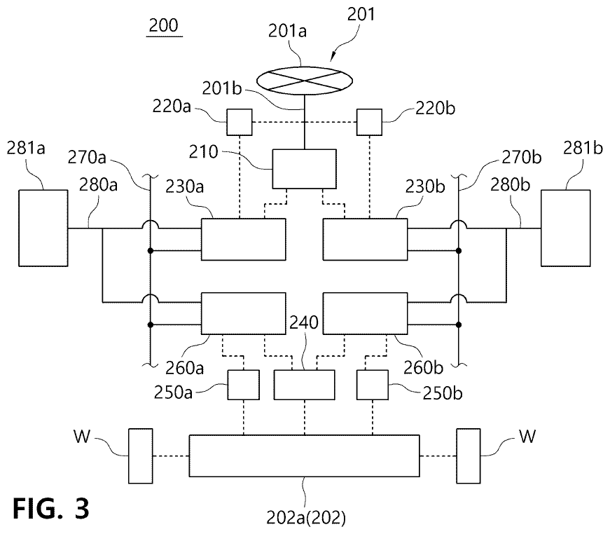

FIG. 3 is a configuration diagram illustrating a steering apparatus according to a second embodiment of the present disclosure.

A steering apparatus 200 according to the second embodiment of the present disclosure is implemented as a steer-by-wire steering system. In the steer-by-wire steering system, a steering wheel and wheels of a vehicle are not mechanically connected and the wheels of the vehicle is steered by an electrical signal, and the steer-by-wire steering system may have high responsiveness and independence for each network. The steering apparatus 200 according to the second embodiment of the present disclosure may include a reaction force actuator 210, a first steering control sensor 220a, a second steering control sensor 220b, a first reaction force control unit or controller 230a, a second reaction force control unit or controller 230b, a steering actuator 240, a first steering mechanism operation sensor 250a, a second steering mechanism operation sensor 250b, a first steering control unit or controller 260a, a second steering control unit or controller 260b, a first communication network 270a, a second communication network 270b, a first power line 280a, and a second power line 280b.

The reaction force actuator 210 may be configured to generate a reaction force against, or in response to, movement or operation of a steering control member 201 operated or controlled by the driver of the vehicle. In the steering apparatus 200 according to the second embodiment of the present disclosure, since the steering control member 201 and wheels W of the vehicle are not mechanically connected, a reaction force torque related to, associated with, or caused by the change in a direction of the wheels W may not be naturally generated. In this situation, the reaction force generated by the reaction force actuator 210 may be provided to a driver through a steering wheel 101a so that the driver may feel an appropriate steering feeling.

For example, the steering control member 201 may include the steering wheel 201a and a steering shaft 201b coupled to the steering wheel 201a of the vehicle. The reaction force actuator 210 may provide a reaction force in a direction opposite to or in response to an operation or rotation direction of the steering wheel 201a through the steering shaft 201b. In the second embodiment of the present disclosure, the reaction force actuator 210 may be, for example, but not limited to, a reaction force motor configured to generate a reaction force torque.

The first steering control sensor 220a may be configured to sense or measure a physical quantity related to, or indicative of, the movement or operation of the steering control member 201 and provide the physical quantity to the first reaction force control unit or controller 230a. In addition, the second steering control sensor 220b may be configured to sense or measure a physical quantity related to, or indicative of, the movement or operation of the steering control member 201 and provide the physical quantity to the second reaction force control unit or controller 230b. The first reaction force control unit 230a and the second reaction force control unit 230b may perform control based on an electrical signal according to the movement or operation of the steering control member 201, and the electrical signal may have a correlation with the physical quantity sensed or measured by the first and/or second steering control sensor 220a, 220b. For example, the physical quantity may include a torque generated during the operation or movement of the steering control member 201 caused by the driver. That is, each of the first steering control sensor 220a and the second steering control sensor 220b may include a torque sensor. In addition, each of the first steering control sensor 220a and the second steering control sensor 220b may include a steering angle sensor. In other words, the physical quantity may include a steering angle or torque of the steering control member 201. In some exemplary embodiments of the present disclosure, the first and/or second steering control sensor 220a, 220b may be configured to sense rotary movement (e.g. a steering angle, speed, or torque) associated with the steering wheel 101a and/or the steering shaft 101b.

The first reaction force control unit (or controller) 230a may be configured to control the reaction force actuator 210 based on an electrical signal (for example, the electrical signal generated by the first and/or second steering control sensor 220a, 220b) according to the movement or operation of the steering control member 201. In addition, the second reaction force control unit (or controller) 230b may be configured to control the reaction force actuator 210 based on the electrical signal (for example, the electrical signal generated by the first and/or second steering control sensor 220a, 220b) along with the first reaction force control unit 230a, or control the reaction force actuator 210 instead of the first reaction force control unit 230a when the first reaction force control unit 230a fails or is not in an active state.

The first reaction force control unit 230a and/or the second reaction force control unit 230b may control the reaction force actuator 210 to generate a reaction force corresponding to the electrical signal. For example, when the reaction force actuator 210 includes a reaction force motor configured to generate a reaction force torque, a control command generated by the first reaction force control unit 230a or the second reaction force control unit 230b may include a torque control command for controlling the reaction force actuator 210.

The first reaction force control unit 230a and/or the second reaction force control unit 230b may control the reaction force actuator 210 to generate a stronger reaction force as the electrical signal is larger. Accordingly, in a case in which a stronger torque is applied to the steering wheel 101a, or a steering angle is larger while the steering control member 201 is operated, the reaction force actuator 210 may generate a stronger reaction force so that a stable steering feeling may be provided.

The first reaction force control unit or controller 230a and/or the second reaction force control unit or controller 230b may include, for example, but not be limited to, a processor, computer, digital signal processor (DSP), memory, storage, register, timing, interrupt, communication interface, and input/output signal interfaces, and the like, as well as combinations comprising at least one of the foregoing. For example, the first reaction force control unit or controller 230a and/or the second reaction force control unit or controller 230b may comprise a processor, a storage medium and/or programmable memory, which are capable of storing and executing one or more algorithms, commands, signals, instructions or methods to effect control of the reaction force actuator 210 and, possibly, other components of the vehicle. The first reaction force control unit or controller 230a and/or the second reaction force control unit or controller 230b may be in communication with the reaction force actuator 210, numerous sensors, communication systems, and other electronic control units (ECU) of the vehicle.

The steering actuator 240 is configured to drive a steering mechanism 202 configured to adjust a direction of the wheels W of the vehicle. The steering mechanism 202 may be driven by the steering actuator 240, and the direction of the wheels W of the vehicle connected to the steering mechanism 202 may be adjusted or changed to steer the vehicle. In the second embodiment of the present disclosure, the steering mechanism 202 may be driven by the steering actuator 240 independently of the steering control member 201 without being mechanically connected to the steering control member 201. For example, the steering actuator 240 may be a drive motor which drives the steering mechanism 202.

The steering mechanism 202 may include a linearly movable member 202a disposed between a pair of wheels W disposed on a front left side and a front right side of the vehicle and connected to the pair of wheels W through a tie rod (not shown) and linearly driven to adjust or change the direction of the wheel W. For example, the linearly movable member 202a may be a rack bar. In this case, the steering actuator 240 may be a drive motor which drives the linearly movable member 202a.

The first steering mechanism operation sensor 250a may be configured to sense or measure movement or operation of the steering mechanism 202, generate information related to the movement or operation of the steering mechanism 202 and provide the information to the first steering control unit 260a. In addition, the second steering mechanism operation sensor 250b may be configured to sense or measure movement or operation of the steering mechanism 202, generate information related to the movement or operation of the steering mechanism 202 and provide the information to the second steering control unit 260b. The steering mechanism 202 is driven by the steering actuator 240, and the first steering control unit 260a and/or the second steering control unit 260b control the steering actuator 240 based on the electrical signal, associated with the movement or operation of the steering control member 101, according to the movement or operation of the steering control member 201. In this case, the first steering mechanism operation sensor 250a and the second steering mechanism operation sensor 250b may provide the information related to or associated with the movement or operation of the steering mechanism 202 to the first steering control unit 260a and the second steering control unit 260b, respectively, so that the information can be used for control together with the electrical signal associated with the movement or operation of the steering control member 101 to accurately and stably control the vehicle. The information related to the movement or operation of the steering mechanism 202 sensed or measured by the first steering mechanism operation sensor 250a and the second steering mechanism operation sensor 250b may reflect impacts, driving environment and the like generated on a road surface on which the vehicle is driving. Accordingly, the steering apparatus according to the second embodiment of the present disclosure is configured to configured to include redundancy by having the first steering mechanism operation sensor 250a and the second steering mechanism operation sensor 250b. Should one of the first steering mechanism operation sensor 250a and the second steering mechanism operation sensor 250b become defective the remaining sensor is still able to furnish the required information.

As described above, when the steering mechanism 202 includes the linearly movable member 202a, the information related to the movement or operation of the steering mechanism 202 may include a position of the linearly movable member 202a, or a position of the steering actuator 240 (e.g. a rotor of a motor). More specifically, when the linear moving member 202a is the rack bar, each of the first steering mechanism operation sensor 250a and the second steering mechanism operation sensor 250b may be a rack position sensor.

The first steering control unit 260a controls the steering actuator 240 based on the electrical signal according to the or movement operation of the steering control member 201. In addition, the second steering control unit 260b controls the steering actuator 240 based on the electrical signal along with the first steering control unit 260a, or controls the steering actuator 240 instead of the first steering control unit 260a when the first steering control unit 260a fails or is not in an active state. For example, when the steering actuator 240 is the drive motor which drives the steering mechanism 202, a control command generated by each of the first steering control unit 260a and the second steering control unit 260b may include a torque control command for controlling the steering actuator 240.

The first steering control unit 260a and the second steering control unit 260b may control the steering actuator 240 to perform steering more as a level indicated by the electrical signal associated with the movement or operation of the steering control member 201 is larger. For example, in a case in which a stronger torque is generated in the steering control member 201, or a steering angle of the steering control member 101 is larger while the steering control member 201 is operated, steering is performed at a relatively larger angle, and in a case in which a relatively smaller torque is generated in the steering control member 201, or a steering angle of the steering control member 201 is smaller while the steering control member 201 is operated, steering is performed at a relatively smaller angle.

Meanwhile, the first steering control unit 260a and the second steering control unit 260b may use the information related to the movement or operation of the steering mechanism 202 measured by the first steering mechanism operation sensor 250a and the second steering mechanism operation sensor 250b to control the steering actuator 240. As described above, the information related to the movement or operation of the steering mechanism 202 sensed or measured by the first steering mechanism operation sensor 250a and the second steering mechanism operation sensor 250b may reflect impacts, driving environment and the like generated on a road surface. The first steering control unit 260a and the second steering control unit 260b may control the steering actuator 240 by considering the information associated with or related to the movement or operation of the steering mechanism in addition to the electrical signal associated with the movement or operation of the steering control member 201 in order to properly perform steering according to a road surface environment and the like.

The first and/or second steering control unit or controller 260a, 260b may include, for example, but not be limited to, a processor, computer, digital signal processor (DSP), memory, storage, register(s), timing, interrupt(s), communication interface, and input/output signal interfaces, and the like, as well as combinations comprising at least one of the foregoing. For example, the first and/or second steering control unit or controller 260a, 260b may comprise a processor, a storage medium and/or programmable memory, which are capable of storing and executing one or more algorithms, commands, signals, instructions or methods to effect control of the steering actuator 240 and, possibly, other components of the vehicle. The first and/or second steering control unit or controller 260a, 260b may be in communication with the steering actuator 240, numerous sensors, communication systems, and other ECUs of the vehicle.

The first communication network 270a is communicationally connected to the first reaction force control unit 230a and the first steering control unit 260a to transmit control-related information to the first reaction force control unit 230a and the first steering control unit 260a. For example, the first communication network 270a may be a CAN or data bus of the vehicle.

The first reaction force control unit 230a and the first steering control unit 260a basically control the reaction force actuator 210 and the steering actuator 240, respectively, based on the electrical signal according to the movement or operation of the steering control member 201. However, various control-related information such as a vehicle speed and autonomous driving commands may be transmitted to the first reaction force control unit 230a and the first steering control unit 260a in addition to the electrical signal, and the first reaction force control unit 230a and the first steering control unit 260a may perform control by considering the various control-related information in addition to the electrical signal. For example, even when electrical signals are the same, degrees of reaction forces and steering of the vehicle may be controlled differently depending on the vehicle speed. In addition, when an autonomous driving command is transmitted, the first reaction force control unit 230a may stop operating.

The various control-related information such as the vehicle speed and the autonomous driving commands described above may be transmitted to the first reaction force control unit 230a and the first steering control unit 260a through the first communication network 270a. The first reaction force control unit 230a and the first steering control unit 260a may use the control-related information received through the first communication network 270a for control.

The second communication network 270b is connected to the second reaction force control unit 230b and the second steering control unit 260b to transmit the control-related information to the second reaction force control unit 230b and the second steering control unit 260b. For example, the second communication network 270b may be a redundant CAN or data bus of the vehicle. Since the second communication network 270b is connected to the second reaction force control unit 230b and the steering control unit 260 to be independent of the first communication network 270a, even when the control-related information such as the vehicle speed and the autonomous driving commands are not transmitted through the first communication network 270a due to a failure in the first communication network 270a, the control-related information may be transmitted through the second communication network 270b. Accordingly, high responsiveness required for the steer-by-wire steering system can be achieved, and system reliability can be improved by securing system redundancy.

The various control-related information such as the vehicle speed and the autonomous driving commands described above may be transmitted to the second reaction force control unit 230b and the second steering control unit 260b through the second communication network 270b. The second reaction force control unit 230b and the second steering control unit 260b may use the control-related information received through the second communication network 270b for control.

The first power line 280a is connected to the first reaction force control unit 230a and the first steering control unit 260a to supply power to the first reaction force control unit 230a and the first steering control unit 260a. The power supplied through the first power line 280a may also be supplied to the reaction force actuator 210, the first steering control sensor 220a, the steering actuator 240, and the first steering mechanism operation sensor 250a.

The second power line 280b is connected to the second reaction force control unit 230b and the second steering control unit 260b to supply power to the second reaction force control unit 230b and the second steering control unit 260b. The power supplied through the second power line 280b may also be supplied to the reaction force actuator 210, the second steering control sensor 220b, the steering actuator 240, and the second steering mechanism operation sensor 250b.

In relation to the supply of the power through the first power line 280a and the second power line 280b, the first reaction force control unit 230a may include a regulator configured to adjust the power supplied to the reaction force actuator 210 and the first steering control sensor 220a, and the second reaction force control unit 230b may include a regulator configured to adjust the power supplied to the reaction force actuator 210 and the second steering control sensor 220b. In addition, the first steering control unit 260a may include a regulator which adjusts the power supplied to the steering actuator 240 and the first steering mechanism operation sensor 250a, and the second steering control unit 260b may include a regulator which adjusts the power supplied to the steering actuator 240 and the second steering mechanism operation sensor 250b.

Meanwhile, a first battery 281a may be connected to the first power line 280a to provide power to the first power line 280a. In addition, a second battery 281b may be connected to the second power line 280b to supply power to the second power line 280b.

In the steering apparatus 200 according to the second embodiment of the present disclosure, the reaction force actuator 210 may be controlled by the first reaction force control unit 230a and the second reaction force control unit 230b, and the steering actuator 240 may be controlled by the first steering control unit 260a and the second steering control unit 260b. Meanwhile, the first reaction force control unit 230a and the first steering control unit 260a receive the control-related information from the first communication network 270a and receive the power from the first power line 280a. In addition, the second reaction force control unit 230b and the second steering control unit 260b receive the control-related information from the second communication network 270b and receive the power from the second power line 280b. As described above, the steering apparatus 200 according to the second embodiment of the present disclosure provides redundancy in controlling the reaction force actuator 210 and the steering actuator 240, and thus system stability can be secured and increased.

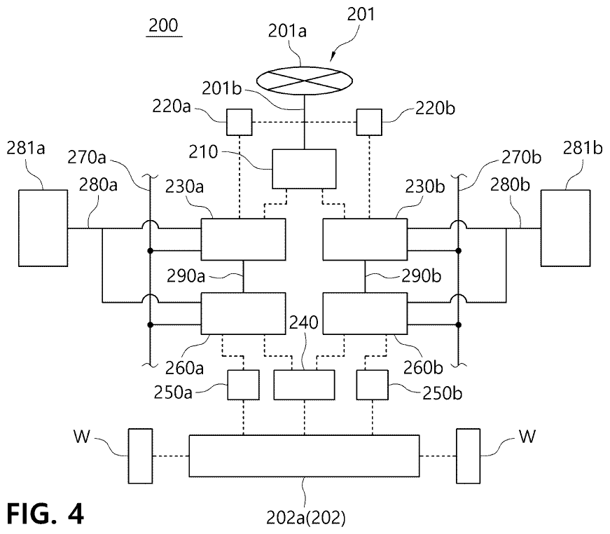

FIG. 4 is a configuration diagram illustrating a steering apparatus according to a first modified example of the second embodiment of the present disclosure.

Referring to FIG. 4, the steering apparatus according to the first modified example of the second embodiment of the present disclosure further includes a first communication line 290a and a second communication line 290b compared to the second embodiment shown in FIG. 3. Since the remaining components are the same as or similar to those described in the second embodiment illustrated in FIG. 3, only the first communication line 290a and the second communication line 290b will be described with respect to the first modified example of the second embodiment of FIG. 4.

The first communication line 290a directly connects the first reaction force control unit or controller 230a and the first steering control unit or controller 260a to allow signal, data or information exchange between the first reaction force control unit 230a and the first steering control unit 260a. In addition, the second communication line 290b directly connects the second reaction force control unit 230b and the second steering control unit 260b to allow signal, data or information exchange between the second reaction force control unit 230b and the second steering control unit 260b.

As described above, the first steering control unit 260a and the second steering control unit 260b may use signal, data or information related to or associated with the movement or operation of the steering mechanism 202 to control the steering actuator 240. This is because the signal, data or information related to the movement or operation of the steering mechanism 202 includes impacts, driving environment and the like which occur on a road surface, and by reflecting this signal, data or information in the control of the steering actuator 240, more appropriate steering control may be performed in correspondence with a road surface environment. The signal, data or information related to the operation of the steering mechanism 202 may also be transmitted to the first reaction force control unit 230a and the second reaction force control unit 230b through the first communication line 290a and the second communication line 290b. Accordingly, the first reaction force control unit 230a and the second reaction force control unit 230b may reflect the signal, data or information related to the movement or operation of the steering mechanism 202 for control of the reaction force actuator 210 and feedback on the road surface environment to more appropriately perform reaction force control.

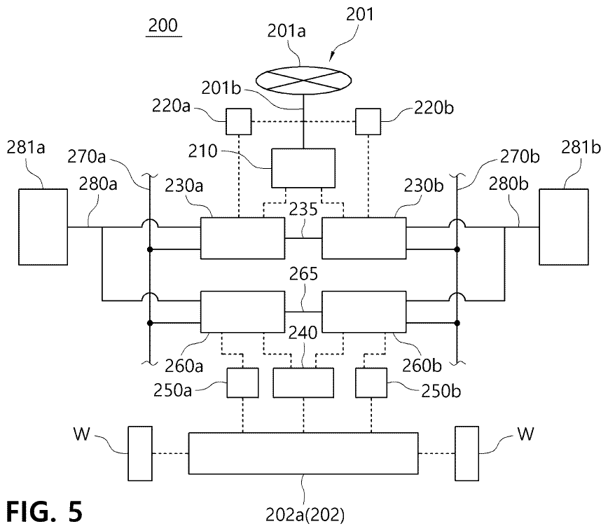

FIG. 5 is a configuration diagram illustrating a steering apparatus according to a second modified example of the second embodiment of the present disclosure.

Referring to FIG. 5, the steering apparatus according to the second modified example of the second embodiment of the present disclosure further includes a communication line 235 between two reaction force control units or controller 230a and 230b and a communication line 265 between two steering control units or controller 260a and 260b compared to the second embodiment shown in FIG. 3. Since the remaining components are the same as similar to those described in relation to the second embodiment illustrated in FIG. 3, only the communication line 235 between the reaction force control units 230a and 230b and the communication line 265 between the steering control units 260a and 260b will be described with respect to the second modified example of the second embodiment of FIG. 3.

The communication line 235 between the reaction force control units 230a and 230b directly connects the first reaction force control unit 230a and the second reaction force control unit 230b. Signal, data or information exchange between the first reaction force control unit 230a and the second reaction force control unit 230b may be performed through the communication line 235 between the reaction force control units 230a and 230b. When the signal, data or information exchange between the first reaction force control unit 230a and the second reaction force control unit 230b is performed through the communication line 235 between the reaction force control units 230a and 230b, the first reaction force control unit 230a and the second reaction force control unit 230b may be synchronized with each other in control, and control efficiency of a reaction force actuator 210 can be improved.

The communication line 265 between the steering control units 260a and 260b directly connects the first steering control unit 260a and the second steering control unit 260b. Signal, data or information exchange between the first steering control unit 260a and the second steering control unit 260b may be performed through the communication line 265 between the steering control units 260a and 260b. When the signal, data or information exchange between the first steering control unit 260a and the second steering control unit 260b is performed through the communication line 265 between the steering control units 260a and 260b, the first steering control unit 260a and the second steering control unit 260b may be synchronized with each other in control, and control efficiency of the steering actuator 240 can be improved.

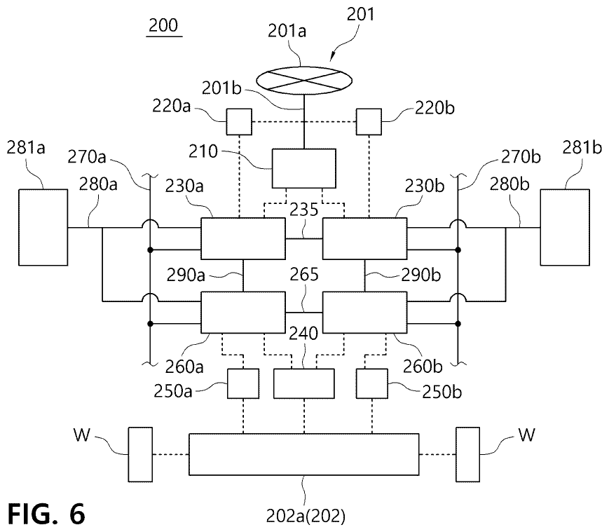

FIG. 6 is a configuration diagram illustrating a steering apparatus according to a third modified example of the second embodiment of the present disclosure.

Referring to FIG. 6, the steering apparatus according to the third modified example of the second embodiment of the present disclosure has a configuration of combination of the first modified example of the second embodiment shown in FIG. 4 and the second modified example of the second embodiment shown in FIG. 5. In other words, the steering apparatus according to the third modified example of the second embodiment illustrated in FIG. 6 includes the first communication line 290a, the second communication line 290b, the communication line 235 between the reaction force control units 230a and 230b, and the communication line 265 between steering control units 260a and 260b. Therefore, the third modified example of the second embodiment of the present disclosure shown in FIG. 6 has both the functions and the effects of the first modified example of the second embodiment illustrated in FIG. 4 and the second modified example of the second embodiment shown in FIG. 5.

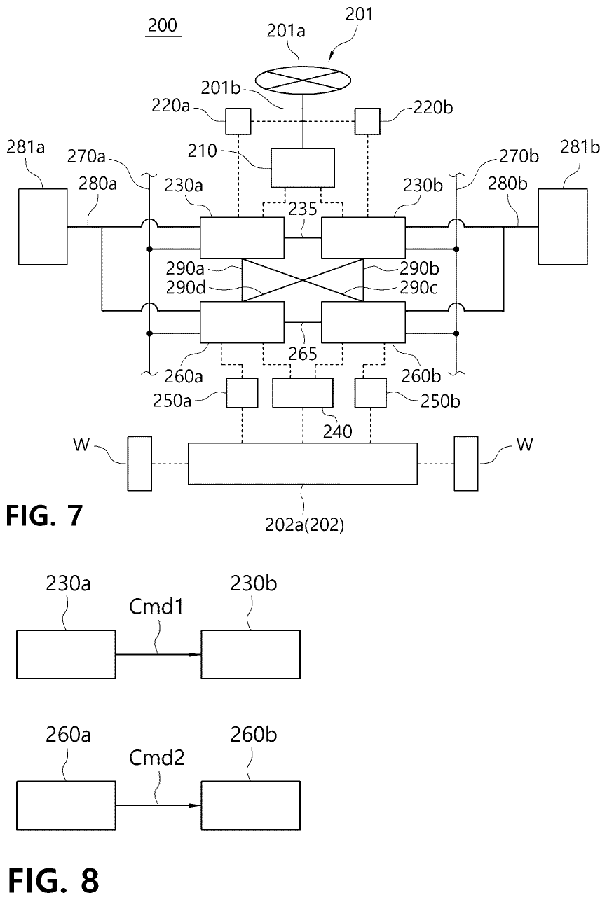

FIG. 7 is a configuration diagram illustrating a steering apparatus according to a fourth modified example of the second embodiment of the present disclosure.

Referring to FIG. 7, the steering apparatus according to the fourth modified example of the second embodiment of the present disclosure further includes a third communication line 290c and a fourth communication line 290d compared to the third modified example of the second embodiment shown in FIG. 6. Since the remaining components are the same as or similar to those described in relation to other modified examples of the second embodiment illustrated in FIGS. 3 to 6, only the third communication line 290c and the fourth communication line 290d will be described with respect to the fourth modified example of the second embodiment of the present disclosure illustrated in FIG. 7.

The third communication line 290c directly connects the first reaction force control unit 230a and the second steering control unit 260b to allow signal, data or information exchange between the first reaction force control unit 230a and the second steering control unit 260b. In addition, the fourth communication line 290d directly connects the second reaction force control unit 230b and the first steering control unit 260a to allow signal, data or information exchange between the second reaction force control unit 230b and the first steering control unit 260a. The third communication line 290c and the fourth communication line 290d may assist or support the first communication line 290a and the second communication line 290b or may be used in place thereof in the case of a failure. Accordingly, system redundancy can be further improved.

FIG. 8 is a view showing an example of the second embodiment of the present disclosure in which two reaction force control units or controller are driven in a master/slave manner, and two steering control units are driven in a master/slave manner. An operation in a master/slave manner shown in FIG. 8 may be implemented in the second to fourth modified examples of the second embodiment shown in FIGS. 4 to 7.

Referring to FIG. 8, in the steering apparatus 200 according to the second embodiment of the present disclosure, the first reaction force control unit or controller 230a may generate a control command Cmd1 for the reaction force actuator 210, and the second reaction force control unit 230b may receive the control command Cmd1 generated by the first reaction force control unit 230a to control the reaction force actuator 210. More specifically, when the reaction force actuator 210 is a reaction force motor which generates a reaction force, the control command Cmd1 generated by the first reaction force control unit 230a may include a torque control command for controlling the reaction force actuator 210.

In addition, in the steering apparatus 200 according to the second embodiment of the present disclosure, the first steering control unit 260a may generate a control command Cmd2 for the steering actuator 240, and the second steering control unit 260b may receive the control command Cmd2 generated by the first steering control unit 260a to control the steering actuator 240. More specifically, when the steering actuator 240 is a drive motor which drives the steering mechanism 202, the control command Cmd2 generated by the first steering control unit 260a may include a torque control command for controlling the steering actuator 240.

For example, when the operation shown in FIG. 8 is performed, control-related signal, data or information provided to the first reaction force control unit 230a and the first steering control unit 260a through the first communication network 270a may actually be used for control. On the other hand, the control-related signal, data or information provided to the second reaction force control unit 230b and the second steering control unit 260b through the second communication network 270b may not be used for control.

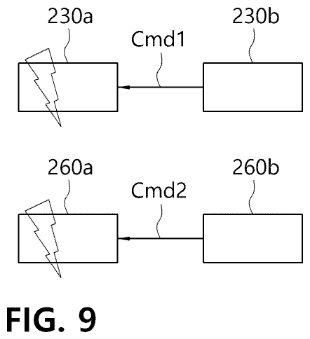

FIG. 9 is a view showing an example of performing control by a slave when a master fails in FIG. 8 according to an embodiment of the present disclosure.

Referring to FIG. 9, in the steering apparatus 200 according to the second embodiment of the present disclosure, when the first reaction force control unit 230a fails, the second reaction force control unit 230b may generate the control command Cmd1 for the reaction force actuator 210. Also, the first reaction force control unit 230a may receive the control command Cmd1 generated by the second reaction force control unit 230b to control the reaction force actuator 210. When the reaction force actuator 210 is a reaction force motor which generates a reaction force, the control command Cmd1 generated by the second reaction force control unit 230b may include a torque control command for the reaction force actuator 210.

In addition, in the steering apparatus 200 according to the second embodiment of the present disclosure, when the first steering control unit 260a fails, the second steering control unit 260b may generate the control command Cmd2 for the steering actuator 240. In addition, the first steering control unit 260a may receive the control command Cmd2 generated by the second steering control unit 260b to control the steering actuator 240. When the steering actuator 240 is a drive motor which drives the steering mechanism 202, the control command Cmd2 generated by the second steering control unit 260b may include the torque control command for controlling the steering actuator 240.

When an operation shown in FIG. 9 is performed, control-related signal, data or information provided to the second reaction force control unit 230b and the second steering control unit 260b through the second communication network 270b may actually be used for control. On the other hand, the control-related signal, data or information provided to the first reaction force control unit 230a and the first steering control unit 260a through the first communication network 270a may not be used for control.

As described above, in the second embodiment of the present disclosure, control efficiency can be improved through the operation in the master/slave manner. In addition, stability and redundancy of the steering system can be improved by the operation in which roles of the master and the slave are switched when the master fails.

According to the above configuration, since a steering apparatus according to some embodiments of the present disclosure is configured so that a control command is transmitted to each of a reaction force control unit or controller and a steering control unit or controller through at least two independent communication networks, the steering apparatus may provide high responsiveness and independence for each network required for a steer-by-wire steering system.

In addition, since a steering apparatus according to certain embodiments of the present disclosure provides independent redundancy in relation to reaction force control and steering control, the steering system can operate properly or accurately even when some components of the steering system fail.

Effects of the present invention are not limited to the above-described effects and should be understood to include all possible effects which may be inferred from the detailed description of the present invention or components of the present invention described in the claims.

While embodiments of the present invention have been described above, the spirit of the present invention is not limited to the embodiments proposed in this specification. Other embodiments may be easily suggested by adding, changing and removing components by those skilled in the art and will fall within the spirit and scope of the present invention.

What is claimed is:

1. A steering apparatus comprising:
a reaction force actuator operably connected to a steering control member operated by a driver of a vehicle, the reaction force actuator configured to generate a reaction force to be provided to the steering control member operated by the driver;
a reaction force controller configured to control the reaction force actuator based on an electrical signal associated with operation of the steering control member operated by the driver;
a steering actuator configured to drive a steering mechanism operably connected to at least one wheel of the vehicle to steer the at least one wheel of the vehicle;
a steering controller configured to control the steering actuator based on the electrical signal associated with the operation of the steering control member operated by the driver;
a first communication network connected to the reaction force controller and the steering controller to transmit a control signal to the reaction force controller and the steering controller; and
a second communication network connected to the reaction force controller and the steering controller independently of the first communication network such that the control signal is transmitted to the reaction force controller and the steering controller through the second communication network independently of the first communication network.

2. The steering apparatus of claim 1, further comprising:
a first power line connected to the reaction force controller and the steering controller to supply power to the reaction force controller and the steering controller; and
a second power line connected to the reaction force controller and the steering controller independently of the first power line so that power is supplied to the reaction force controller and the steering controller through the second power line independently of the first power line.

3. The steering apparatus of claim 2, further comprising:
a first battery connected to the first power line to provide the power to the first power line; and
a second battery connected to the second power line to provide the power to the second power line.

4. The steering apparatus of claim 1, further comprising a communication line directly connecting between the reaction force controller and the steering controller such that the reaction force controller and the steering controller directly communicate each other through the communication line.

5. The steering apparatus of claim 1, further comprising a steering control sensor configured to measure a physical quantity related to the operation of the steering control member operated by the driver, and provide the measured physical quantity to the reaction force controller,
wherein the electrical signal has a correlation with the physical quantity related to the operation of the steering control member operated by the driver.

6. The steering apparatus of claim 5, wherein the physical quantity includes a torque generated by the operation of the steering control member operated by the driver.

7. The steering apparatus of claim 1, further comprising a steering mechanism operation sensor configured to sense movement related to operation of the steering mechanism operated by the driver, and transmit to the steering controller a signal associated with the sensed movement related to the operation of the steering mechanism operated by the driver.

8. The steering apparatus of claim 7, wherein:
the steering mechanism includes a linearly movable member; and
the signal associated with the sensed movement related to the operation of the steering mechanism operated by the driver includes a position of the linearly movable member.

9. A steering apparatus comprising:
a reaction force actuator configured to generate a reaction force to be provided to a steering control member operated by a driver of a vehicle;
a first reaction force controller configured to control the reaction force actuator based on an electrical signal associated with operation of the steering control member operated by the driver;
a second reaction force controller configured to control the reaction force actuator based on the electrical signal along with or instead of the first reaction force controller;
a steering actuator configured to drive a steering mechanism operably connected to at least one wheel of the vehicle to steer the at least one wheel of the vehicle;
a first steering controller configured to control the steering actuator based on the electrical signal associated with the operation of the steering control member operated by the driver;
a second steering controller configured to control the steering actuator based on the electrical signal along with or instead of the first steering controller;
a first communication network connected to the first reaction force controller and the first steering controller to transmit a control signal to the first reaction force controller and the first steering controller; and
a second communication network connected to the second reaction force controller and the second steering controller such that the control signal is transmitted to the second reaction force controller and the second steering controller through the second communication network.

10. The steering apparatus of claim 9, further comprising:
a first power line connected to the first reaction force controller and the first steering controller to supply power to the first reaction force controller and the first steering controller; and
a second power line connected to the second reaction force controller and the second steering controller to supply power to the second reaction force controller and the second steering controller.

11. The steering apparatus of claim 10, further comprising:
a first battery connected to the first power line to provide the power to the first power line; and
a second battery connected to the second power line to provide the power to the second power line.

12. The steering apparatus of claim 9, further comprising:
a first communication line directly connecting between the first reaction force controller and the first steering controller such that the first reaction force controller and the first steering controller directly communicate each other through the first communication line; and
a second communication line directly connecting between the second reaction force controller and the second steering controller such that the second reaction force controller and the second steering controller directly communicate each other through the second communication line.

13. The steering apparatus of claim 9, further comprising:
a first steering control sensor configured to measure a physical quantity related to the operation of the steering control member and provide the physical quantity to the first reaction force controller; and
a second steering control sensor configured to measure a physical quantity related to the operation of the steering control member operated by the driver, and provide the physical quantity to the second reaction force controller,
wherein the electrical signal has a correlation with the physical quantity related to the operation of the steering control member operated by the driver.

14. The steering apparatus of claim 13, wherein the physical quantity includes a torque generated by the operation of the steering control member operated by the driver.

15. The steering apparatus of claim 9, further comprising:
a first steering mechanism operation sensor configured to sense movement related to operation of the steering mechanism, and transmit to the first steering controller a first signal associated with the sensed movement related to the operation of the steering mechanism; and
a second steering mechanism operation sensor configured to sense the movement related to the operation of the steering mechanism, and transmit to the second steering controller a second signal associated with the sensed movement related to the operation of the steering mechanism.

16. The steering apparatus of claim 15, wherein:
the steering mechanism includes a linearly movable member; and
the first and/or second signal associated with the sensed movement related to the operation of the steering mechanism includes a position of the linearly movable member.

17. The steering apparatus of claim 9, further comprising a communication line disposed between the first reaction force controller and the second reaction force controller, and directly connecting between the first reaction force controller and the second reaction force controller.

18. The steering apparatus of claim 9, further comprising a communication line disposed between the first steering controller and the second steering controller, and directly connecting between the first steering controller and the second steering controller.

19. The steering apparatus of claim 9, wherein:
the first reaction force controller is configured to generate a control command for the reaction force actuator; and
the second reaction force controller is configured to receive the control command generated by the first reaction force controller to control the reaction force actuator, and generate the control command for the reaction force actuator when the first reaction force controller fails.

20. The steering apparatus of claim 19, wherein:
the reaction force actuator includes a reaction force motor configured to generate a reaction force; and
the control command for the reaction force actuator includes a torque control command for controlling a torque of the reaction force actuator.

21. The steering apparatus of claim 9, wherein:
the first steering controller is configured to generate a control command for the steering actuator; and
the second steering controller is configured to receive the control command generated by the first steering controller to control the steering actuator, and generate the control command for the steering actuator when the first steering controller fails.

22. The steering apparatus of claim 21, wherein:
the steering actuator includes a driving motor configured to drive the steering mechanism; and
the control command for the steering actuator includes a torque control command for controlling a torque of the steering actuator.
